(19) United States
(12) Patent Application Publication
(10) Pub. No.: US 2010/0303072 A1
(43) Pub. Date: Dec. 2, 2010

(54) Multicast Source Mobility

(76) Inventors: Petri Jokela, Espoo (FI); Jan Melen, Espoo (FI); Jukka Ylitalo, Espoo (FI)

Correspondence Address: COATS & BENNETT, PLLC, 1400 Crescent Green, Suite 300, Cary, NC, 27518, US

(21) Appl. No.: 12/744,739

(22) PCT Filed: Nov. 28, 2007
(86) PCT No.: PCT/EP07/62967

§ 371 Date: May 26, 2010

(51) Int. Cl. H04L 12/56

(52) U.S. Cl. 370/390

(57) ABSTRACT

A method of delivering an IP multicast stream from a source node to a destination node. The method comprises establishing a Host Identity Protocol association between a multicast router and at least one further network node upstream of the multicast router, both of which are present in the multicast path, and using said association(s) to transport multicast packets.

### TECHNICAL FIELD

The present invention relates to a method and apparatus for supporting source mobility in an IP multicast scenario.

### BACKGROUND

IP multicast is a mechanism for efficiently delivering IP content to end users (“clients”) from a source. IP multicast differs from unicast (one-to-one delivery) and broadcast (one-to-all delivery) in that it makes use of network based multicast routers (MCs) to distribute a single incoming IP stream to a set of clients and/or further MCs which belong to a given multicast group. IP multicast is considered an excellent technology for the delivery of bandwidth hungry services such as IP television (IPTV).

IP multicast is at this stage a technology rather than a specific standard or set of standards. That said, protocols such a User Datagram Protocol (UDP) and Real Time Protocol (RTP) are currently used to frame multimedia data and to ensure an appropriate Quality of Service. In multicast routing, the source IP address is used to determine data stream direction at the MCs. A MC determines which downstream interfaces are destinations for a packet by mapping the source address of the packet to a multicast group and sends the packet out through those interfaces. The term “reverse path forwarding” is used to describe this concept of routing packets away from the source, rather than towards the destination. Clients wishing to join a multicast group and to thereby receive data originating at a particular multicast source address, will use the Internet Group Management Protocol (IGMP) in order to register with an upstream MC. MCs themselves use the Protocol Independent Multicast (PIM) to register with upstream MCs in a hierarchical structure.

An IP multicast group is uniquely identified by the notation (G,S), where G is the multicast group address, and S is the IP address of the source node for the multicast stream. G is selected from a range of IP addresses (allocated by the Internet Assigned Numbers Authority) and does not itself identify a specific location. It will be appreciated that a number of multicast groups can have the same group address G, but can be distinguished by different source address. When a host wishes to receive a multicast, it uses the multicast identity (G,S) to register with a MC, i.e. it sends an IGMP join instruction containing the multicast group identity. The join instruction is routed towards the source address S until it arrives at a multicast router, where the host is added to the appropriate group.

Given that the source address S is contained within the multicast group identity, and this address is tied to a fixed location, source mobility is not supported easily. Consider for example the case where a wireless IP multicast source is located within a moving vehicle and the physical contact address of the source is changed each time the source is handed-off to a new access point. In this case, the source address contained within packets sent from the source will change with each hand-off. Downstream MCs will be unable to map the received packets to a valid group following a hand-off, and the packets will be discarded without delivery to the intended destinations.

### SUMMARY

It is an object of the present invention to overcome the problems considered above, and in particular to enable mobility of a multicast source node. This an other objects are achieved in part by using the Host Identity Protocol to handle mobility. A multicast network tree can be subdivided into sub-trees, with each branch of the tree being traversed by a HIP association extending between HIP enabled multicast routers, client terminals, and/or source nodes.

According to a first aspect of the present invention there is provided a method of delivering an IP multicast stream from a source node to a destination node, the method comprising establishing a Host Identity Protocol association between a multicast router and at least one further network node upstream of the multicast router, both of which are present in the multicast path, and using said association(s) to transport multicast packets.

Said network node may be a further multicast router. Alternatively, it may be said source node.

The method may comprise, in the event that the source IP address of said source node changes, sending a HIP UPDATE containing the new source IP address from said network node to the first mentioned multicast router, receipt of the UPDATE at the multicast router causing the router to send a service discovery message towards the source node. The sending of said HIP UPDATE is triggered by receipt at said further multicast router of a HIP UPDATE from a further upstream router or said source node.

According to a second aspect of the present invention there is provided an IP multicast router comprising a Host Identity Protocol client and being arranged to establish a Host Identity Protocol association with an upstream multicast router between itself and an IP multicast source node, or with an IP multicast source node, for the purpose of transporting an IP multicast stream from the source node to a downstream destination node.

According to a third aspect of the present invention there is provided a user terminal comprising a Host Identity Protocol client, the terminal being arranged to send a service discovery message to a multicast router and which contains a first multicast group identity, to establish a Host Identity Protocol association with said multicast router, to receive a second multicast group identity from said multicast router, to send a join instruction to said multicast router containing said second multicast group identity, and to subsequently receive an IP multicast stream over said Host Identity Protocol association.

### BRIEF DESCRIPTION OF THE DRAWINGS

FIG. 1 illustrates the various layers in the Host Identity Protocol;

FIG. 2 illustrates the operation of the four-way handshake in the HIP protocol;

FIG. 3 shows the logical and actual packet structures in HIP;

FIG. 4 illustrates schematically an IP multicast network architecture comprising HIP multicast routers;

FIG. 5 shows a signalling flow within the network of FIG. 4 associated with establishing a multicast stream from a multicast source to a client;

FIG. 6 shows a signalling flow within the network of FIG. 5 associated with movement of the multicast source;

FIG. 7 shows a signalling flow within a multicast network architecture and illustrates the piggybacking of a multicast stream on an already established HIP association;

FIG. 8 shows a signalling flow within a multicast network architecture whereby holes in the multicast network are traversed using tunnels;

FIG. 9 illustrates schematically various nodes within the network architecture of FIG. 4; and

FIG. 10 shows a signalling flow associated with an optimised multicast joining procedure.

### DETAILED DESCRIPTION

An IP address describes a topological location of a node in a network. The IP address is used to route IP packets from a source node to a destination node. At the same time the IP address is also used to identify a node, thus providing two different functions in one entity. This is akin to a person's name and address being synonymous. When mobility is also considered, the situation becomes even more complicated: since IP addresses act as host identifiers, they should not be changed; however, since IP addresses also describe topological locations, they must necessarily change when a host changes its location in the network. Clearly, it is impossible to achieve both stability and dynamic changes at the same time.

A solution to the problem of mobility handling is provided by the Host Identity Protocol (HIP) proposal (R. Moskowitz, P. Nikander, P. Jokela, “Host Identity Protocol”, Internet Draft, work in progress, draft-ietf-hip-base-09.txt, IETF, 2007). HIP separates the location and identity roles of IP addresses by introducing a new name-space, the Host Identity (HI). In HIP, the Host Identity is a public cryptographic key of a public-private key-pair. The public key identifies the party that holds the only copy of the private key. A host possessing the private key of the key-pair can directly prove that it “owns” the public key that is used to identify it in the network.

The HIP Host Identity (HI), being a public key, can be quite long. It is therefore often represented with a 128-bit long Host Identity Tag (HIT) that is generated from the HI by hashing it. Thus, the HIT identifies a HI. Since the HIT is 128 bits long, it can be used for IPv6 applications directly as it is exactly the same length as an IPv6 address.

Applications are typically not interested in a (peer) node's location, but do need to know the identity of the peer. The identity is represented by the HIT. This means that the IP address only has importance on lower layers where routing is concerned. The HITs, which the applications use must of course be mapped to the corresponding IP addresses before any packets leave a node. This is achieved in a new Host Identity Layer as will now be described.

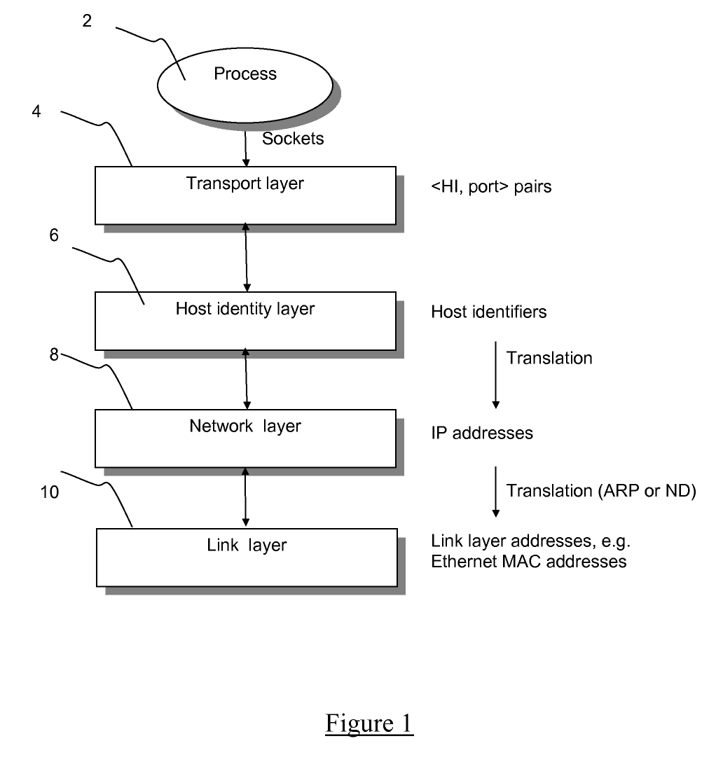

FIG. 1 of the accompanying drawings illustrates the various layers in a HIP-based protocol architecture, comprising the standard transport layer 4, network layer 8 and link layer 10, with a process 2 communicating with the transport layer 4 below it. The new Host Identity Layer 6 is disposed between the transport layer 4 and the network layer 8. A primary role of the Host Identity Layer is to perform the mapping between HITs and IP addresses. Each packet arriving from the upper layer contains the HIT of a peer node as the destination address. The Host Identity Layer replaces the destination HIT with the appropriate destination IP address, and the source HIT is converted to the appropriate source IP address.

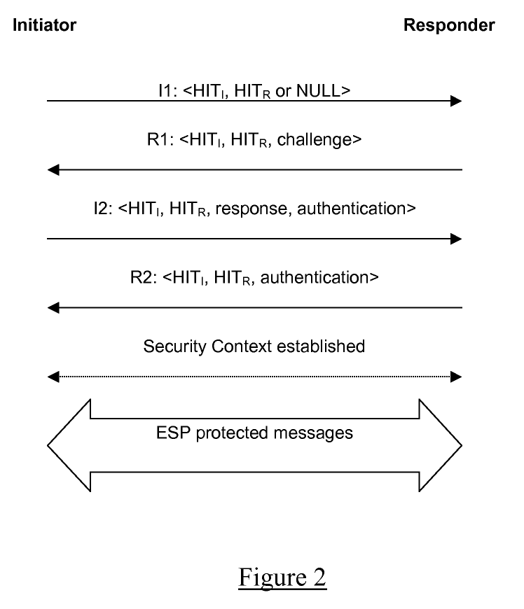

HIP defines a base message exchange containing four messages, i.e. a four-way handshake, and this is used to create a security association (SA) between HIP-enabled nodes. During the message exchange, the Diffie-Hellman procedure is used to create a session key and to establish a pair of IPsec Encapsulating Security Payload (ESP) Security Associations (SAs) between the nodes. FIG. 2 of the accompanying drawings illustrates the four-way handshake. The negotiating parties are referred to as the “Initiator”, starting the connection, and the “Responder”. The Initiator begins the negotiation by sending an I1 packet that contains the HITs of the nodes participating in the negotiation. When the Responder receives the I1 packet, it sends back an R1 packet that contains a puzzle to be solved by the Initiator. The protocol is designed so that the Initiator must do most of the calculation during the puzzle solving. This gives some protection against Denial-of-Service (DoS) attacks. The R1 initiates also the Diffie-Hellman procedure, containing the public key of the Responder together with the Diffie-Hellman parameters.

Once the R1 packet is received, the Initiator solves the puzzle and sends a response cookie in an I2 packet together with an IPsec SPI value and its encrypted public key to the Responder. The Responder verifies that the puzzle has been correctly solved, authenticates the Initiator and creates the IPsec ESP SAs. The final R2 message contains the SPI value of the Responder.

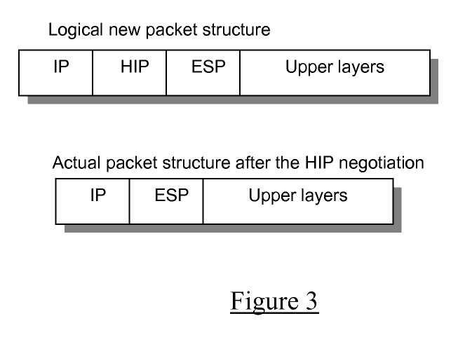

The SAs between peer nodes are bound to the Host Identities, represented by the HITs. However, the packets travelling in the network do not contain the actual HI (HIT) information, but rather the arriving packet is identified and mapped to the correct SA using the Security Parameter Index (SPI) value in the ESP header. FIG. 3 of the accompanying drawings shows the logical and actual packet structures of a packet travelling in the network.

When an outgoing packet arrives at the HI layer from a higher layer, the destination HIT is verified from the IPsec SADB. If an SA matching the destination HIT is found, the packet payload is encrypted using the session key associated with the SA, and the source and destination IP addresses are substituted into the packet IP header for the source and destination HITs. At the receiving host, the SPI value is used to find the correct SA from the IPsec SADB. If an entry is found, the source and destination IP addresses can be changed to the corresponding HITs and the packet can be decrypted using the session key.

HIP can provide a solution to the problem of handling source mobility in an IP multicast architecture. In particular, it is proposed here to introduce into the multicast architecture so-called HIP multicast routers (HIP-MCs). The role of a HIP-MCs is to receive multicast traffic from a higher “layer” multicast, that traffic having one identifier (G,S), and to map the traffic to another identifier (G1,S1) for distribution across a lower layer multicast. As such, the HIP-MCs split a single multicast tree into a number of smaller sub-trees.

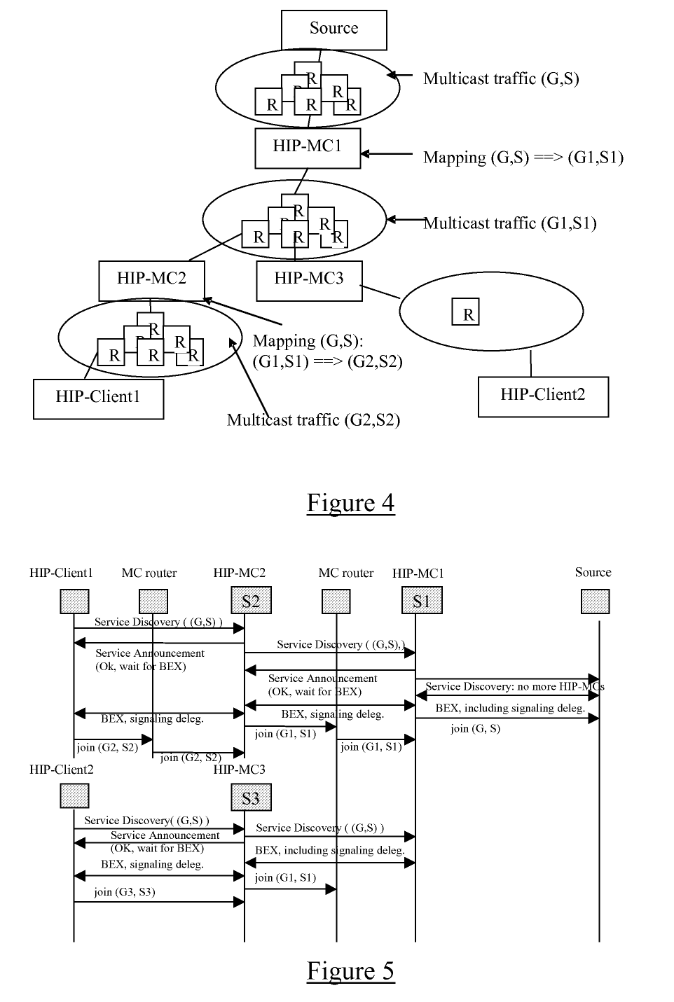

An example architecture is illustrated in FIG. 4, with a source (at source address S) providing an IP multicast stream for distribution to a number of clients, only two of which are illustrated in the Figure. It is assumed that the clients are all HIP clients, although non-HIP clients located behind HIP proxies may be present. In addition to the HIP-MCs, the architecture contains a number of conventional MCs, identified in the Figure by “R”.

In order to allow a client (e.g. HIP-Client1) to join a multicast group, the client must first obtain an identifier for the corresponding multicast stream, i.e. (G,S) in this case. How the client obtains the identifier is outside the scope of this document, although it could be, for example, via a web interface. Assuming that the client knows the group identifier, it does not immediately initiate a join procedure as it would normally do, but rather first tries to locate a HIP-MC between itself and the source node. To do this, the client initiates a HIP service discovery procedure as illustrated in FIG. 5. The service discovery message (functioning as an I1 message of the HIP base exchange) needs to contain the original stream identifier (G,S), and uses opportunistic mode as, at this stage, the client does not yet know the HIT of the first hop HIP-MC.

The service discovery message is routed towards the source address S until it arrives at the first HIP-MC, in this case HIP-MC2. In the event that HIP-MC2 is already providing multicast services for HIP nodes, HIP-MC2 checks if it already has the (G,S) multicast stream coming from some source. Assuming that this is not the case, HIP-MC2 creates a new local group (G2,S2) and associates this with the group identifier (G,S), where S2 is HIP-MC2's own IP address and G2 a new group id that HIP-MC2 has selected for this stream. HIP-MC2 informs HIP-Client1 that the service discovery was successful, and that the HIP base exchange (BEX) between HIP-Client1 and HIP-MC2 will delayed until the router has received enough information from the source side (e.g. certificate from the source). To this end, a Service Announcement is sent to the client, including a new “WAIT” field which informs the client that it should wait until it receives the R1 packet before attempting to complete the HIP Base Exchange.

HIP-MC2 initiates a similar service discovery procedure (again in opportunistic mode as it does not know the HIT of the next hop HIP-MC) towards the source, resulting in HIP-MC1 receiving the message which again contains the identifier (G,S). Assuming that HIP-MC 1 is not already receiving the corresponding multicast stream, it creates a local group (G1,S1) and maps this to (G,S). HIP-MC1 repeats the service discovery procedure, but this time the service discovery message is received at the source. The HIP Base Exchange (R1, I2, R2) then completes between HIP-MC1 and the source. This cascades back through the chain, completing the Base Exchange between HIP-MC2 and HIP-MC1, and between HIP-Client 1 and HIP-MC2. HIP-Client1 receives the HIT of HIP-MC2 in the R1 message.

During the HIP Base Exchange, HIP-MC1 needs to inform HIP-MC2 about the mapping (G,S) to (G1,S1) so that the HIP-MC2 can subsequently initiate the join procedure for (G1,S1) and make the final mapping for (G,S), namely (G1,S1) to (G2,S2). This information is conveyed in the R2 message of the Base Exchange. The join procedure is a traditional IP multicast join (i.e. according to IGMP in IPv4 and MLD in IPv6). Similarly, during the HIP negotiation between HIP-Client1 and HIP-MC2, the client is informed about the mapping (G,S) to (G2,S2). The client can then initiate the join procedure using (G2,S2).

The HIP Base Exchange also completes the service registration procedure for the HIP multicast service. Service registration is defined in IETF “draft-ietf-hip-registration”. Following the sending of the I1 message (that is the service discovery message in this case), the responder returns the R1 together with service information on the services that it provides: In this case about the HIP multicast service. The client then sends the I2 message, together with a registration for the service. Thus, the service registration procedure is integrated into the HIP base exchange.

Of course, there may be multiple conventional MC routers (non-HIP aware) in the path between the client and the two HIP-MCs. However, these MCs are transparent to the HIP signalling, and merely intercept and process a join instruction according to standard procedures.

FIG. 5 also illustrates the procedure when a second HIP client, HIP-Client2, wishes to join the multicast group (G,S) in the event that HIP-Client1 has already joined. It is assumed that HIP-Client2 learns the identity of a further HIP-MC, namely HIP-MC3. HIP-Client2 initiates the service discovery procedure using the group identity (G,S), and receives back a wait instruction. In this example, HIP-Client3 initiates an upstream service discovery procedure, and learns that HIP-MC1 is already handling the stream (G,S) and has mapped this to (G1,S1). There is no need for further upstream service discovery, and the Base Exchanges between HIP-MC3 and HIP-MC1 and between HIP-Client2 and HIP-MC3 are completed, before sending the join instructions.

In some cases a certificate may be provided to the client in order to allow it to authenticate the source. As part of the base exchange between the source and HIP-MC1, the source provides to the HIP-MC2 a certificate that guarantees the identity of the source. HIP-MC1 then delegates this certificate to the next multicast router HIP-MC2 and so on until the HIP-Client finally receives the certificate from which it can verify the chain and see that the last HIP-MC has actually been given the right to deliver the stream.

Consider now the case where the source moves from address S to a new address S′. Thus, whilst the old identifier (G,S) points to the old location of the source node, the new identifier (G,S′) points to the new location. By building the overall tree using partial trees, it is only necessary to update those trees that are affected by the source node mobility. The remainder of the tree remains the same and can continue to use the old (Gn,Sn) group for that traffic.

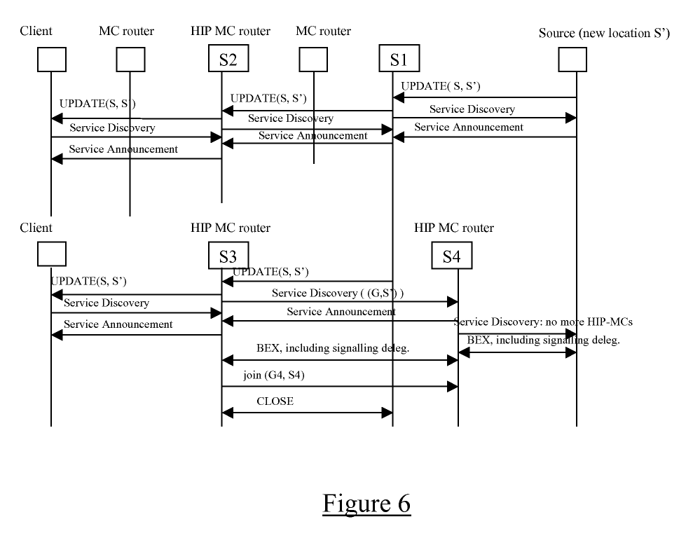

When the source node moves, it creates a HIP UPDATE message containing its new IP address and delivers this to the HIP-MC to which it has a connection (i.e. HIP-MC1 in FIG. 5). [If appropriate, the source node can establish an IP tunnel to HIP-MC1 to allow the source node to deliver data packets to the multicast network until a new tree is built towards the source node. NB. Such an IP tunnel involves using as the destination address for multicast packets, the address of the destination HIP-MC rather than the associated group address.] This HIP-MC then sends the UPDATE message further to all (HIP-MC) nodes registered with it and receiving the multicast identified by (G,S). Ultimately, the UPDATE is sent to the HIP client. As each HIP node receives the UPDATE, it records a change in the group identity to (G,S′) and reinitiates the service discovery procedure. If a HIP node determines from the Service Announcement response that the next step HIP-MC is the same as previously used, the initiating node can continue using that next step HIP-MC and no actions are required, i.e. there is no need to repeat the HIP Base Exchange between the two nodes. This is the case illustrated for the uppermost client in the signalling flow of FIG. 6.

When a HIP node receives an UPDATE and determines from the Service Announcement response that the next step HIP-MC has changed, the initiating node must create a new association with the new HIP-MC and send a CLOSE to the previously used HIP-MC in the upstream direction. This is illustrated for the lowermost client in the signalling flow of FIG. 6. Note that a HIP-MC must not close any connections other than the one across which it received the CLOSE message as it is possible that it is still in the path when considering other HIP-MCs that have received (G,S) identified flow through it. Thus, for example, HIP-MC S1 in FIG. 6 must not delete the HIP association that it has established with HIP-MC S2 as a result of receiving the CLOSE instruction from S3.

It is noted that although the stream identity is converted to (G,S′) at each HIP node, the old stream identity (G,S) may be maintained active for a while in case some new clients, unaware of the new stream identity, attempt to join the multicast group using the old identity.

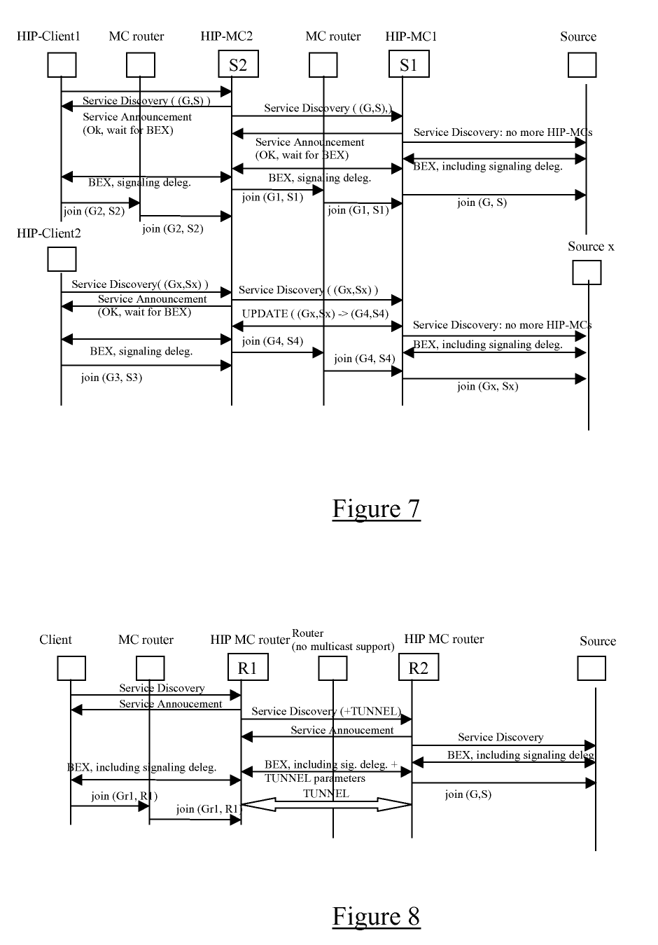

It is possible to allow subsequently established multicast streams to piggyback on already established HIP associations. This is illustrated in FIG. 7 where a HIP association has been established in respect of a group (G,S), initiated by HIP-Client1. When HIP-Client2 subsequently initiates a service discovery procedure in respect of a further multicast group (Gx,Sx), where the source of the multicast is Sx rather than S, HIP-MC2 learns that a HIP association with HIP-MC1 already exists. There is therefore no need for a further HIP base exchange between the two HIP multicast routers, and the existing HIP association is reused. A HIP update exchange is however required in order to transfer the mapping between (Gx,Sx) and (G4,S4) from HIP-MC1 to HIP-MC2.

It is possible that there are areas without multicast support in a network. This problem can be addressed as follows. When a HIP-MC determines that there are non-multicast enabled routers present in the path between itself and the next hop HIP-MC (i.e. the HIP-MC does not have information of other PIM routers that are announcing themselves with hello messages) and which could be used for receiving the multicast channel, it registers with the next step HIP-MC with a new “TUNNEL” option in the registration message (registration done during the Base Exchange). The request for setting up a tunnel can alternatively be included in the service discovery message. The HIP-MCs establish a IP tunnel between themselves for delivering multicast traffic between the nodes as illustrated by the signalling flow of FIG. 8, where R1 and R2 are the two HIP-MCs with a non-multicast enabled router interposed between them. This approach ensures that a bridge can be created between isolated IP multicast “islands”. The data packet processing does not differ from the normal processing, after the tunnel encapsulation/decapsulation has been performed.

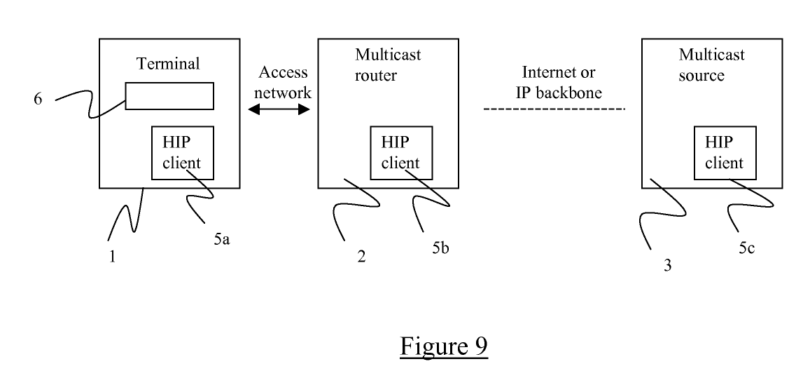

FIG. 9 illustrates in simplified schematic form a user terminal 1, HIP-MC 2, and multicast source node 3 for use with the present invention. Each entity comprises a HIP client 5a, 5b, 5c, whilst the user terminal comprises, in this example, a display 6 for receiving a multicast video stream, e.g. an IPTV stream.

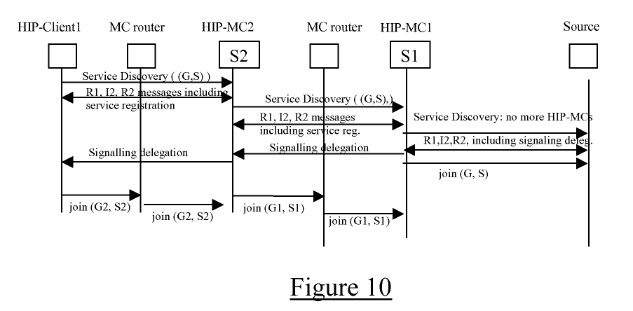

It will be appreciated by the person of skill in the art that various modifications may be made to the above described embodiments without departing from the scope of the present invention. For example, the message exchange may be optimised over that illustrated in FIG. 5. According to the flow of FIG. 5, the first client (HIP-Client1) joining the group must wait until all message exchanges towards the source have been completed before completing the HIP base exchange with the first hop HIP-MC and before sending the join instruction. The reason for this is that the certificate (confirming that for example (G2,S2) is validly mapped to (G,S)) is not available to the client until the upstream base exchanges have been completed. However, the base exchange between the client and the first hop HIP-MC and the sending of the join instruction could be run even prior to completion of the upstream exchanges, with the final certificate being delivered at a later stage. This is illustrated in the signalling flow of FIG. 10.

1. A method of delivering an IP multicast stream from a source node to a destination node, the method comprising establishing a Host Identity Protocol association between a multicast router and at least one further network node upstream of the multicast router, both of which are present in the multicast path, and using said association(s) to transport multicast packets.

2. A method according to claim 1 and comprising performing a Host Identity Protocol discovery procedure between said multicast router and said network node in respect of said IP multicast stream, subsequently performing said step of establishing a Host Identity Protocol association between the multicast router and said network node, and subsequently sending a multicast join instruction from the multicast router to the network node.

3. A method according to claim 2, wherein said network node is a further multicast router.

4. A method according to claim 3, wherein a service discovery procedure involves sending a service discovery message from the first mentioned multicast router to the further, upstream multicast router, the message identifying the IP multicast stream using a first group IP address and a first source IP address, the method comprising delivering, as part of a Host Identity Protocol base exchange to establish said Host Identity Protocol association, a local group IP address and local source IP address allocated to the multicast group by said further multicast router, from the upstream router to the downstream router, and at the downstream router mapping said first group and source IP address to said local group and source IP address, said join instruction containing as multicast group identity said local group and source IP address.

5. A method according to claim 4, wherein said local group IP address and local source IP address are delivered within the R2 message of the Host Identity Protocol base exchange.

6. A method according to claim 4 and comprising, in response to receipt of said service discovery message at the upstream router, returning from the upstream router to the downstream router a service announcement containing a wait instruction, the downstream router responding to receipt of the wait instruction by waiting for an R1 message of the Host Identity Protocol base exchange from the upstream router.

7. A method according to claim 3, said step of establishing a Host Identity Protocol association between said two multicast routers being triggered by receipt at the downstream one of the multicast routers, of a service discovery message from said destination node or a further downstream multicast router.

8. A method according to claim 7 and comprising, in response to receipt of the service discovery message from said destination node or a further downstream multicast router, establishing a Host Identity Protocol association between said destination node or said further downstream router and the downstream one of said at least two multicast routers, and subsequently sending a multicast join instruction from said destination node or said further downstream router to the downstream one of said at least two multicast routers.

9. A method according to claim 1 and comprising receiving a service discovery message in respect of said IP multicast stream at the first mentioned multicast router following establishment of the Host Identity Protocol association between that multicast router and said network node, establishing a further Host Identity Protocol association between the first mentioned multicast router and a second destination node or further downstream multicast router at which the service discovery message originated, subsequently sending a multicast join instruction from said second destination node or said further downstream router to the first mentioned multicast router, and delivering multicast packets received on said first mentioned Host Identity Protocol association towards the second destination node over said further Host Identity Protocol association.

10. A method according to claim 3 and comprising, in the event that the source IP address of said source node changes, sending a HIP UPDATE containing the new source IP address from said network node to the first mentioned multicast router, receipt of the UPDATE at the multicast router causing the router to send a service discovery message towards the source node.

11. A method according to claim 10 wherein the sending of said HIP UPDATE is triggered by receipt at said further multicast router of a HIP UPDATE from a further upstream router or said source node.

12. A method according to claim 11 and comprising, in the event that the service discovery message is sent to a new upstream multicast router, following receipt of a response from that router at said further multicast router, establishing a Host Identity Protocol association between said further multicast router and the new upstream router, sending a join instruction from said further multicast router to the new upstream router, and carrying the IP multicast stream across the new association.

13. A method according to claim 12 and comprising, sending from the first mentioned multicast router to said further multicast router a close instruction in order to terminate the old Host Identity Protocol association.

14. A method according to claim 1 and comprising, in the event that one or more non-multicast enabled routers are present in the multicast path between said first mentioned multicast router and said network node, establishing a tunnel between the multicast router and the network node in order to transparently convey packets protected by said Host Identity Protocol association through the intervening router(s).

15. A method according to claim 14 and comprising including in a service discovery message or a Host Identity Protocol base exchange message, sent from said first mentioned multicast router to said network node, a request to establish said tunnel.

16. A method according to claim 1, wherein said further network node is said source node.

17. An IP multicast router comprising a Host Identity Protocol client and being arranged to establish a Host Identity Protocol association with an upstream multicast router between itself and an IP multicast source node, or with an IP multicast source node, for the purpose of transporting an IP multicast stream from the source node to a downstream destination node.

18. A router according to claim 17 and arranged to send a service discovery message to said upstream router or said source node containing a first multicast group identity and, following receipt of a service announcement from the upstream router, to carry out said step of establishing a Host Identity Protocol association.

19. A router according to claim 18 and arranged to receive from said upstream router, either in said service announcement or in a Host Identity Protocol base exchange message, a local multicast group identity provided by the upstream router, to map said first multicast group identity to said local group identity, and to send a join instruction to the upstream router containing said local group identity.

20. A router according to claim 19, wherein said first multicast group identity consists of a group multicast IP address and an IP address of a multicast source node, and said local multicast group identity consists of a second group IP address allocated by said upstream multicast router and an IP address of the upstream multicast router.

21. A router according to claim 17 and arranged in use to receive a multicast service discovery message from a further downstream multicast router or a destination node, to subsequently establish said Host Identity Protocol association with said upstream router, to establish a further Host Identity Protocol association with said further downstream router or said destination node, to allocate a local multicast group identity to the IP multicast, and to inform the further downstream router or the destination node of the local group identity.

22. A router according to claim 21 and arranged to receive a join instruction from said further downstream router or said destination node containing said local group identity, and to join the further downstream router or said destination node to the multicast group.

23. A router according to claim 17 and arranged to receive a Host Identity Protocol UPDATE from the upstream multicast router in the event that the multicast source obtains a new IP address and, in response to issue a corresponding UPDATE to downstream routers and to repeat an upstream service discovery procedure.

24. A router according to claim 17 and arranged, upon receipt of a service discovery message from a downstream multicast router or from a destination node, to determine whether or not a Host Identity Protocol association has already been established towards said source node in respect of the multicast group to which the message relates, and if such an association has been established, to route the stream received over that association to the destination node or downstream multicast router.

25. A router according to claim 17 and arranged, upon receipt of a HIP UPDATE message from said upstream multicast router or said multicast source node, to send a service discovery message towards the source node.

26. A user terminal comprising a Host Identity Protocol client, the terminal being arranged to send a service discovery message to a multicast router and which contains a first multicast group identity, to establish a Host Identity Protocol association with said multicast router, to receive a second multicast group identity from said multicast router, to send a join instruction to said multicast router containing said second multicast group identity, and to subsequently receive an IP multicast stream over said Host Identity Protocol association.

27. A terminal according to claim 26, wherein said first multicast group identity consists of a group multicast IP address and an IP address of a multicast source node, and said second multicast group identity consists of a second group IP address allocated by said multicast router and an IP address of the multicast router.

28. A terminal according to claim 26, the terminal being arranged to receive from said multicast router, in response to the sending of said service discovery message, a service announcement, and thereafter to await a further Host Identity Protocol base exchange message from the multicast router.
